(19) United States
(12) Patent Application Publication
(10) Pub. No.: US 2022/0414749 A1
(43) Pub. Date: Dec. 29, 2022

(54) SERVER DEVICE AND ELECTRONIC COMMERCE TRANSACTION METHOD

(71) Applicant: 17LIVE JAPAN INC., Tokyo (JP)

(72) Inventor: Hirofumi ONO, Tokyo (JP)

(21) Appl. No.: 17/779,082

(22) PCT Filed: Nov. 25, 2019
(86) PCT No.: PCT/JP2019/045938

§ 371 Date: May 23, 2022

(51) Int. Cl. G06Q 30/06; G06Q 50/00

(52) U.S. Cl. CPC G06Q 30/0635; G06Q 50/01

(57) ABSTRACT

A server device includes: a monitoring unit monitoring inputs performed by a plurality of users through one or more UI objects displayed together with a live video on a terminal of each of the plurality of users, the live video being about a product and distributed to the plurality of users from a first user; an extraction unit extracting, from the inputs, a specific input related to a purchase order for the product; a processing unit performing a process of accepting the purchase order for the product upon extraction of the specific input; and an output unit, upon extraction of the specific input, outputting data for displaying information regarding the purchase order for the product on a terminal used by a second user who made the specific input among the plurality of users.

### TECHNICAL FIELD

The present invention relates to a technology for selling products through online videos.

### BACKGROUND

There are known technologies for selling products online to a large number of users. For example, Patent Literature 1 discloses a system that performs processing related to purchase of products when a specific keyword is found in comments posted on a SNS (Social Networking Service). Patent Literature 2 discloses a system in which a user sends an invitation including product information to a number of other users, and terminals receiving this invitation may purchase this product.

### RELEVANT REFERENCES

### List of Relevant Patent Literature

Patent Literature 1: Taiwanese Patent No. 1578252
Patent Literature 2: United States Patent Application Publication No. 2014/0081791

### SUMMARY

In Patent Literatures 1 and 2, products are introduced using still images and mere messages, and thus the information conveyed from the seller to the buyer is limited.

In contrast, the present invention provides a technology for selling products through online videos.

According to one aspect of invention, provided is a server device. The server device includes: a monitoring unit monitoring inputs performed by a plurality of users through one or more UI objects displayed together with a live video on a terminal of each of the plurality of users, the live video being about a product and distributed to the plurality of users from a first user; an extraction unit extracting, from the inputs, a specific input related to a purchase order for the product; a processing unit performing a process of accepting the purchase order for the product upon extraction of the specific input; and an output unit, upon extraction of the specific input, outputting data for displaying information regarding the purchase order for the product on a terminal used by a second user who made the specific input among the plurality of users.

The one or more UI object may include a first object for accepting input of comments about the live video. The monitoring unit monitors the comments, and the extraction unit extracts, from the comments, a first key word that indicates the purchase order of the product. The output unit may output the data in response to the extraction of the first key word.

The extraction unit may extract a second key word from comments inputted by the second user, the second key word corresponding to the first key word and indicating cancellation of the purchase order for the product. The server device may further include a cancellation unit canceling the purchase order for the product upon extraction of the second key word from the comments inputted by the second user.

The extraction unit may extract a character string that indicates a combination of an identifier and order quantity of the product.

The extraction unit may extract, as the specific input, an input for specifying at least one selecting from the group consisting of an identifier, an attribute, and an order quantity of the product.

The output unit may output, as the data, data for displaying a comment on the terminal, the comment indicating the purchase order for the product has been accepted.

The output unit may output, as the data, data for displaying a link on the terminal, the link linking to a site for settling a purchase cost of the product.

The output unit may output, as the data, data for displaying a comment corresponding to the specific input, the comment being superimposed on the live video.

The output unit may output data for displaying, on the terminal, a first UI object among the one or more UI objects corresponding to the live video on the terminal, the first UI object showing the input of the second user with a different appearance from a second UI object that shows an input of a third user different from the second user.

The output unit may output data for displaying, on the terminal, a third UI object among the one or more UI objects corresponding to the live video on the terminal, the specific input by the second user being extracted from the third UI object with a different appearance from a fourth UI object from which no specific input is extracted.

The output unit may output the data in response to acceptance of the purchase order for the product by the processing unit.

The server device may further include an identifying unit identifying a product on sale in the live video. Upon identification of the product on sale in the live video by the identifying unit, the extraction unit may extract an input that indicates an order quantity as the specific input.

When the specific input is extracted, the processing unit may perform a process of settling a purchase cost of the product.

According to another aspect of invention, provided is an electronic commerce transaction method. The method includes: monitoring inputs performed by a plurality of users through one or more UI objects displayed together with a live video on a terminal of each of the plurality of users, the live video being about a product and distributed to the plurality of users from a first user; extracting, from the inputs, a specific input related to a purchase order for the product; performing a process of accepting the purchase order for the product upon extraction of the specific input; and upon extraction of the specific input, outputting data for displaying information regarding the purchase order for the product on a terminal used by a second user who made the specific input among the plurality of users.

### Advantageous Effects

The present invention facilitates selling products online through videos.

### BRIEF DESCRIPTION OF THE DRAWINGS

FIG. 1 schematically illustrates a live commerce system 1 related to one embodiment.

FIG. 2 illustrates a functional configuration of the live commerce system 1.

FIG. 3 illustrates a hardware configuration of a server 20.

FIG. 4 illustrates a hardware configuration of a distributor user terminal 30.

FIG. 5A illustrates a network configuration of the live commerce system 1.

FIG. 5B illustrates another network configuration of the live commerce system 1.

FIG. 6 is a sequence chart showing an overview of operation of the live commerce system 1.

FIG. 7 illustrates a live video viewing screen of a viewer user terminal 40.

FIG. 8 illustrates a keyword database.

FIG. 9 illustrates a viewing screen in which comments including keywords are posted.

FIG. 10 is a flowchart illustrating a process of purchase order for a product.

FIG. 11 illustrates a purchase order database.

FIG. 12 illustrates a comment display screen for a video.

FIG. 13 illustrates another comment display screen.

FIG. 14 illustrates a keyword database related to a modification

### LIST OF REFERENCE NUMBERS

1 . . . live commerce system, 10 . . . server, 11 . . . storage unit, 12 . . . communication unit, 13 . . . distribution unit, 20 . . . server, 21 . . . storage unit, 22 . . . communication unit, 23 . . . monitoring unit, 24 . . . extraction unit, 25 . . . processing unit, 26 . . . output unit, 30 . . . distributor user terminal, 31 . . . storage unit, 32 . . . shooting unit, 33 . . . communication unit, 34 . . . control unit, 35 . . . input unit, 40 . . . viewing user terminal, 41 . . . storage unit, 42 . . . communication unit, 43 . . . control unit, 44 . . . display unit, 45 . . . input unit, 91 . . . SNS, 92 . . . viewing application, 93 . . . distribution app, 99 . . . window, 101 . . . processor, 102 . . . memory, 103 . . . storage, 104 . . . communication if, 201 . . . processor, 202 . . . memory, 203 . . . storage, 204 . . . communication IF, 301 . . . processor, 302 . . . memory, 303 . . . storage, 304 . . . communication module, 305 . . . touch screen, 306 . . . microphone, 307 . . . camera, 401 . . . processor, 402 . . . memory, 403 . . . storage, 404 . . . communication module, 405 . . . touch screen, 911 . . . icon, 912 . . . icon, 913 . . . icon, 914 . . . comment, 915 . . . icon, 916 . . . comment, 917 . . . input field, 918 . . . button, 921 . . . icon, 922 . . . comment, 923 . . . comment, 924 . . . comment, 925 . . . comment

### DESCRIPTION OF EXAMPLE EMBODIMENTS

### 1. Configuration

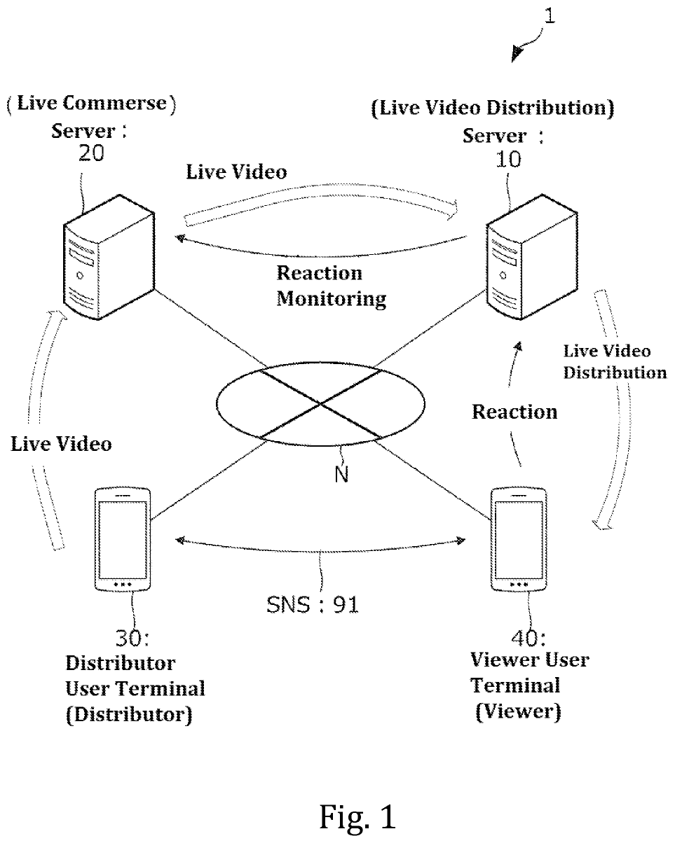

FIG. 1 schematically illustrates a live commerce system 1 related to one embodiment. The live commerce system 1 includes a server 10, a server 20, a distributor user terminal 30, and a viewer user terminal 40. The server 10 is a server for providing a service of live streaming videos. “Live stream” refers to shooting and distributing videos in real time (or almost simultaneously), in other words, live distribution of videos. Further, a video distributed through live streaming is referred to as a “live video”, and a user who distributes a live video is referred to as a “distributor” (or streamer). The “distributor” herein encompasses a performer who appears in a video, a cameraman who shoots the performer, and an operator who operates the distributor user terminal 30, which may be different users, in the distribution of the live video. The server 20 is a server for providing a service for selling products through live streaming videos (hereinafter referred to as “live commerce service”). The distributor user terminal 30 is a user terminal used by a distributor who performs live streaming of a video. The viewer user terminal 40 is a user terminal used by a viewer who receives the live distribution of the video. These devices are interconnected over a network N (e.g., the Internet).

In this example, the live video is distributed via SNS (Social Networking Service) 91. In one example, the SNS 91 may be Facebook (registered trademark), Instagram (registered trademark), or twitter (registered trademark). The SNS 91 provides communication between users although via the server 10 and the like, thus the arrows that connects the distributor user terminal 30 and the viewer user terminal represents the SNS 91 in the drawing.

The server 10 is a server for providing the SNS 91. The server 10 and the server 20 may be operated by different entities. A user (i.e., a “viewer” or “recipient”) accessing the SNS 91 to view live videos uses a viewing application 92. The viewing application 92 is an application program for accessing the SNS 91 on the viewer user terminal 40 (e.g., a client program dedicated to SNS 91 or a general-purpose browser program). The viewing application 92 displays UI (User Interface) objects along with a live video on the viewing user terminal 40. The UI objects are image objects that are displayed on an UI screen to receive user operation inputs. In one example, the image objects are a comment input field, a like button, and a share button in Facebook (registered trademark). A user (i.e., a distributor, an example of a first user) uses a live streaming application 93 for live streaming a video through the SNS 91 to sell products. The streaming application 93 is an application program (e.g., a client program dedicated to the server 20) for distributing live a video on the distributor user terminal 30 to the SNS 91 and for managing the sale of products. In this embodiment, the operator of the live commerce system 1 is not necessarily the same as the operator of the SNS 91. In other words, the operator of the live commerce system 1 can divert the existing SNS 91 to the live commerce service.

In the live commerce system 1, the distributor uses the service provided by the server 10 to distribute videos that introduce products from the distributor user terminal 30 to multiple viewers. The viewers receive the videos on their viewer user terminals 40. During the delivery of a video, a viewer is able to input his/her reaction to the video via an UI object. The reaction is, for example, posting of his/her comment. The server 20 monitors reactions to the video from the viewers. When a specific reaction is inputted, for example, when a specific keyword (or specific string of characters) is included in a comment, the server 20 performs a process related to ordering a product depending on the reaction inputted, for example, depending on the string of characters. The viewer user terminal 40 used by the user who posted a comment including the specific string of characters among the multiple users (i.e., the user who ordered a product or an example of the second user) shows information regarding the order of this product (e.g., information indicating that the order of the product has been accepted). The server 10 and server 20 may be herein collectively referred to as the “server,” and the viewer user terminal 40 and distributor user terminal 30 may be collectively referred to as “user terminal”.

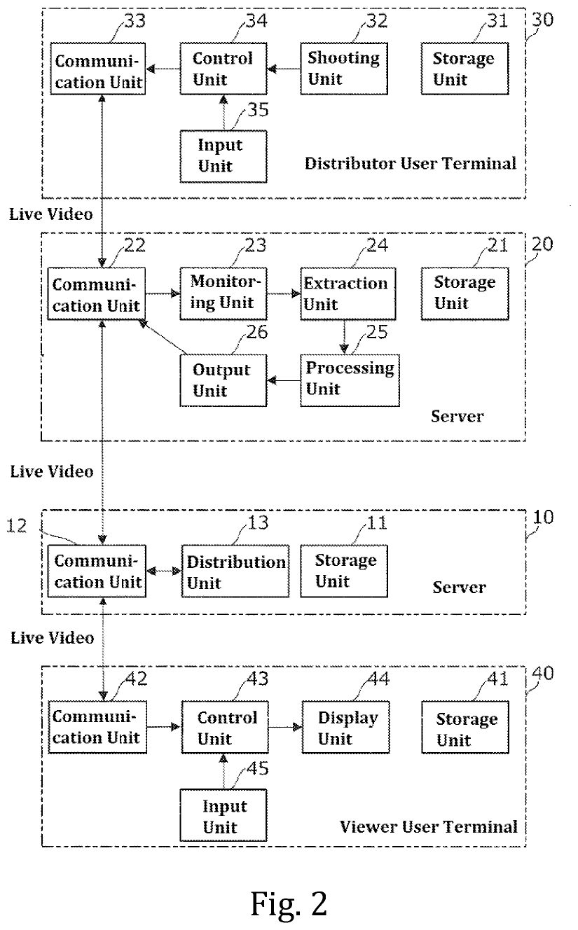

FIG. 2 illustrates a functional configuration of the live commerce system 1. The live commerce system 1 includes a storage unit 31, a shooting unit 32, a communication unit 33, a control unit 34, an input unit 35, a storage unit 21, a communication unit 22, a monitoring unit 23, an extraction unit 24, a processing unit 25, an output unit 26, a storage unit 11, a communication unit 12, a distribution unit 13, a storage unit 41, a communication unit 42, a control unit 43, a display unit 44, and an input unit 45. Of these, the storage unit 11, the communication unit 12, and the distribution unit 13 are included in the server 10. The storage unit 21, the communication unit 22, the monitoring unit 23, the extraction unit 24, the processing unit 25, and the output unit 26 are included in the server 20. The storage unit 31, the shooting unit 32, the communication unit 33, the control unit 34, and the input unit 35 are included in the distributor user terminal 30. The storage unit 41, the communication unit 42, the control unit 43, the display unit 44, and the input unit 45 are included in the viewer user terminal 40.

In the distributor user terminal 30, the storage unit 31 stores various data and programs. The shooting unit 32 shoots videos to be distributed (hereinafter referred to as “target videos”). The input unit 35 receives instructions or information inputted by the user (i.e., the distributor). The control unit 34 generates video data to be delivered based on the video captured by the shooting unit 32 and the instructions inputted via the input unit 35. The communication unit 33 transmits the target video data to the server 10. The communication unit 33 also transmits information identifying the target video to the server 20.

In the server 10, the storage unit 11 stores various data and programs. The communication unit 12 performs communication with external devices such as the distributor user terminal 30 and the viewer user terminal 40 over the network. The distribution unit 13 distributes the target video received from the distributor user terminal 30 to other terminal devices such as the viewer user terminal 40.

In the server 20, the storage unit 21 stores various data and programs. The communication unit 22 performs communication with external devices such as the server 10 over the network. The monitoring unit 23 monitors comments posted by users other than the distributor about the target video. The extraction unit 24 (or detection unit) extracts (or detects) a specific keyword(s) related to order placement(s) of a product(s) from the monitored comments. The processing unit 25 performs processing related to an order placement(s) of a product(s). The output unit 26 outputs data for displaying information regarding the order on the viewer user terminal 40. The “information regarding the order” is a reply (or comment) to the posted comment containing the keyword. The replay indicates that the order for the product has been accepted. Alternatively, the “information regarding the order” is data for showing a comment that responds to the keyword in the target video.

In the viewer user terminal 40, the storage unit 41 stores various data and programs. The communication unit 42 performs communication with external devices such as the server 10 over the network. In this example, the communication unit 42 accesses server 10 to receive delivery of videos. The display unit 44 displays the videos delivered from server 10. The input unit 45 accepts input from the user (i.e., viewer) of information, in this example, comments on a video. The communication unit 42 transmits the inputted comments to the server 10.

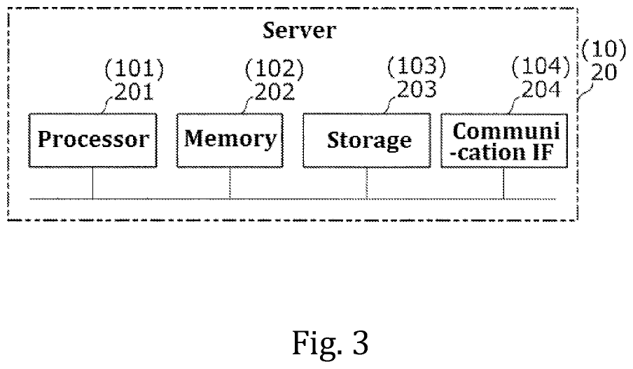

FIG. 3 illustrates the hardware configuration of the server 20. The server 20 is a computer device having a processor 201, memory 202, storage 203, and communication IF 204. The processor 201 performs various operations according to a program. The memory 202 is a main memory device that functions as a work area for the processor 201 performing operations. The memory 202 includes, for example, ROM (Read Only Memory) and RAM (Random Access Memory). The storage 203 is an auxiliary memory device that stores various data and programs, and includes, for example, SSD (Solid State Drive) or HDD (Hard Disk Drive). The communication IF 204 perform communication with other devices in conformity with a predetermined communication standard (e.g., Ethernet (registered trademark)).

In this example, the storage 203 stores a program (hereinafter referred to as “LC server program”) for causing the computer device to function as the server 20 in the live commerce system 1. When the processor 201 executes the LC server program, (a part of) the functions of FIG. 2 are implemented in the computer device. When the processor 201 is executing the LC server program, the processor 201 is considered as an example of the monitoring unit 23, the extraction unit 24, the processing unit 25, and the output unit 26. At least one of the storage 203 or the memory 202 is an example of the storage unit 21. The communication IF 204 is an example of the communication unit 22.

The server 10 has the same hardware configuration as the server 20 and is indicated by the corresponding reference numerals in parentheses in FIG. 3. The storage 103 stores a program (hereinafter referred to as “video server program”) for causing the computer device to function as the server 10 in the live commerce system 1. When the processor 101 executes the video server program, (a part of) the functions of FIG. 2 are implemented in the computer device. When the processor 101 is executing the video server program, the processor 101 is an example of the distribution unit 13. At least one of the storage 103 or the memory 102 is an example of the storage unit 11. The communication IF 104 is an example of the communication unit 12.

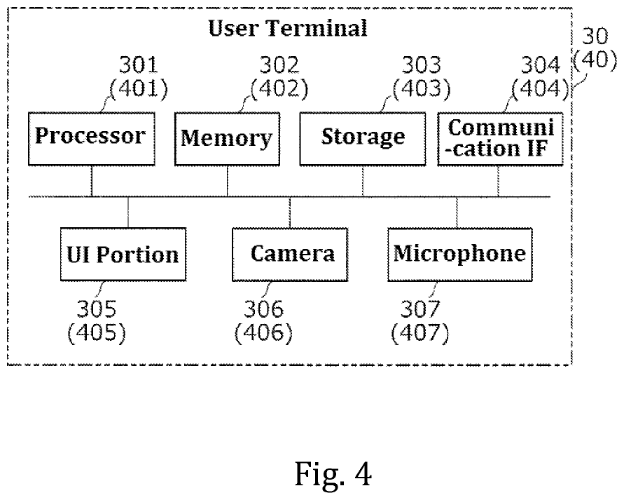

FIG. 4 illustrates the hardware configuration of the distributor user terminal 30. The distributor user terminal 30 is a computer device, e.g., smartphone or tablet terminal, having a processor 301, memory 302, a storage 303, a communication module 304, a touch screen 305, a microphone 306, and a camera 307. The processor 301 performs various operations according to a program. The memory 302 is a main memory device that functions as a work area for the processor 301 performing operations. The memory 302 includes, for example, ROM and RAM. The storage 303 is an auxiliary memory device that stores various data and programs, and includes, for example, SSD or HDD. The communication module 304 perform communication with other devices in conformity with a predetermined communication standard (e.g., at least one of LTE (Long Term Evolution) or Wi-Fi). The touch screen 305 is an input/output device that functions both as a display device for displaying information and as an input device for inputting information or instructions. The microphone 306 is a voice input device for inputting voice. The camera 307 is a video input device for shooting video or capturing still images.

In this example, the storage 303 stores a program (hereinafter referred to as “distributor client program”) for causing the computer device to function as the distributor user terminal 30 in the live commerce system 1. When the processor 301 executes the distributor client program, (a part of) the functions of FIG. 2 are implemented in the computer device. When the processor 301 is executing the distributor client program, the camera 307 is an example of the shooting unit. The communication module 304 is an example of the communication unit 33. At least one of the storage 303 or the memory 302 is an example of the storage unit 31.

The viewer user terminal 40 has the same hardware configuration as the distributor user terminal 30 and is indicated by the corresponding reference numerals in parentheses in FIG. 4. The storage 403 stores a program (hereinafter referred to as “viewer client program”) for causing the computer device to function as the distributor user terminal 40 in the live commerce system 1. When the processor 401 is executing the viewer client program, a communication module 404 is an example of the communication unit 42. The touch screen 405 is an example of the display unit 44. At least one of the storage 403 or the memory 402 is an example of the storage unit 41.

### 2. Operation

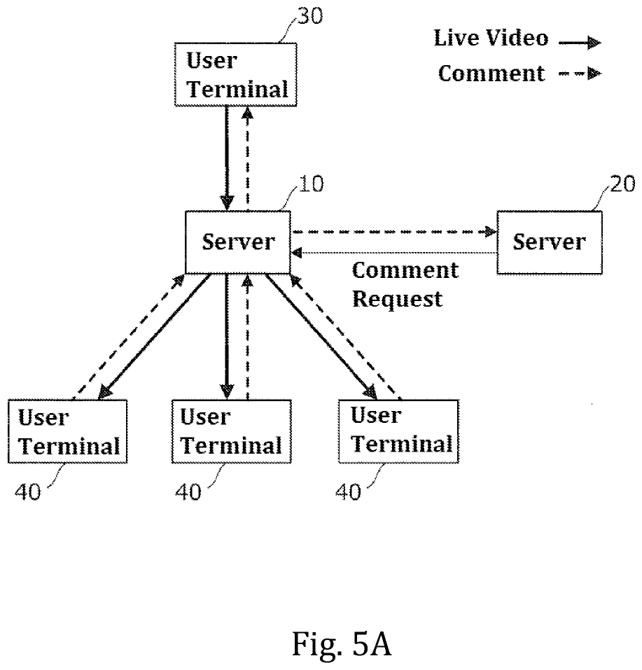

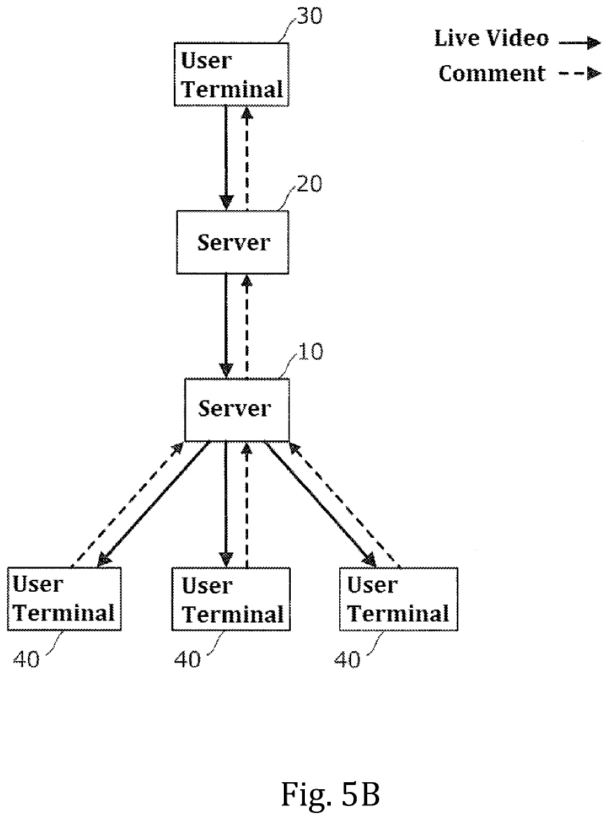

FIG. 5A illustrates the network configuration of the live commerce system 1. Before describing specific operation of the live commerce system 1, the network configuration of the live commerce system 1 will be described. There are several possible network configurations for the live commerce system 1, and FIG. 5A shows one of them.

In the example of FIG. 5A, the live video data flows from the distributor user terminal 30 to the viewer user terminal 40 via the server 10. The server 20 is not part of this data flow. The server 20 obtains the comments posted to the target video from the server 10 and analyzes them. In this configuration, the server 20 does not involve in the distribution of the target video, so that the processing load on the server 20 can be reduced.

FIG. 5B illustrates another network configuration of the live commerce system 1. In this example, the server 20 relays uploading of video and downloading of comments from the distributor user terminal 30 to the server 10. In this configuration, the comments posted to the target video pass through the server 20, which has the advantage of reducing the load of comment monitoring at the server 20. In this configuration, since the server 20 manages the video uploads, there is an advantage that the video can be distributed via servers other than the server 10, i.e., via SNSs on different platforms than the SNS 91 (multi-platform video distribution).

The configurations of FIGS. 5A and 5B have different advantages from each other. The following describes the operation of the live commerce system 1 having the configuration of FIG. 5A as one example.

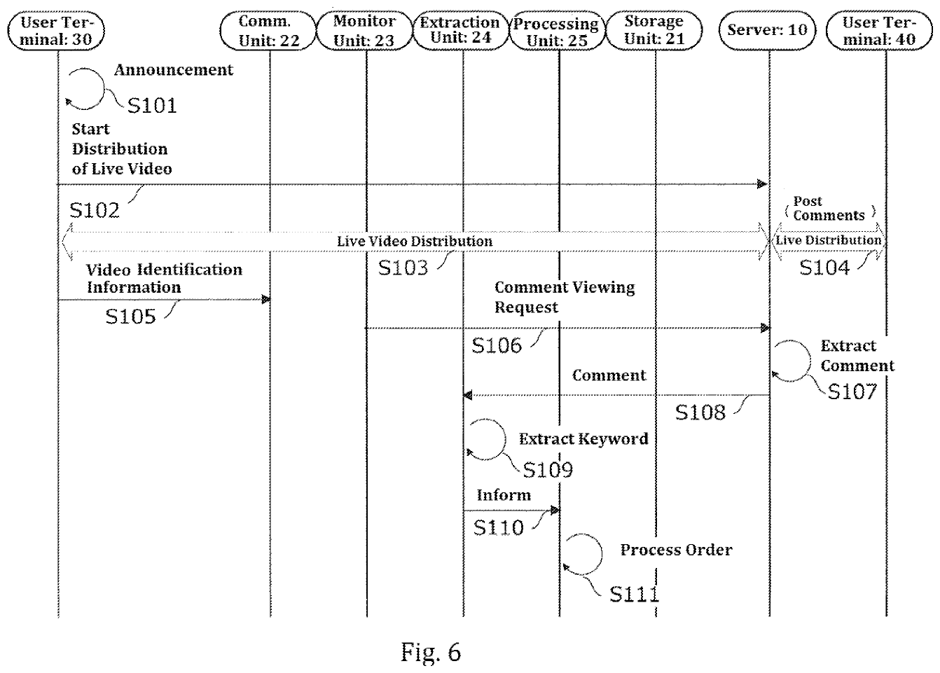

FIG. 6 is a sequence chart showing an overview of the operation of the live commerce system 1. In the following, functional elements such as the monitoring unit 23 may be described as the processor elements, which means that hardware elements such as the processor 201 work with software such as the LC server program to control other hardware elements such as the memory 202 to perform processing.

In step S101, the distributor announces a live video distribution beforehand. For example, the distributor accesses the SNS from the distributor user terminal 30 and posts a comment (or message) on the SNS to announce the live video distribution. Although the live video is distributed via the predetermined SNS (in this case, the SNS 91), the announcement may be made on a different SNS than the SNS 91. The announcement includes information to identify the live video (e.g., distributor's user ID and the scheduled distribution time on the SNS, which is the distribution platform of the live video).

When the announced time approaches, the distributor starts the distributor client program on the distributor user terminal 30. In this example, the distributor client program is a client application program of the SNS 91. The UI objects (e.g., buttons or icons) are provided on the UI screen of the distributor client program for starting the distribution of a live video, and the distributor can instruct the start of the live video distribution through this UI object. Upon receiving the instruction to start the distribution, the distributor user terminal 30 starts distribution of images (live video) captured by the camera 307 (Step S102). In other words, the distributor user terminal 30 uploads the live video to the server 10 continuously thereafter (Step S103).

Once the live video is uploaded to the server 10, the live distribution is possible. When the viewer user terminal 40 accesses the server 10 and transmits instruction for viewing the target video, the live video is distributed to the viewer user terminal 40 (Step S104).

When the start of the live video distribution is instructed, the distributor user terminal 30 transmits, to the server 20, information identifying the target video (hereinafter referred to as “video identification information”) (Step S105). The video identification information includes, for example, the platform for the video distribution, the user name on that platform, and the scheduled start time of the video distribution. When the video distribution platform assigns identification information (hereinafter referred to as “video ID”) to each video, this video ID may be used as the video identification information. The video identification information may be transmitted to the server 20 prior to the start of the live video distribution, or after the distribution has started.

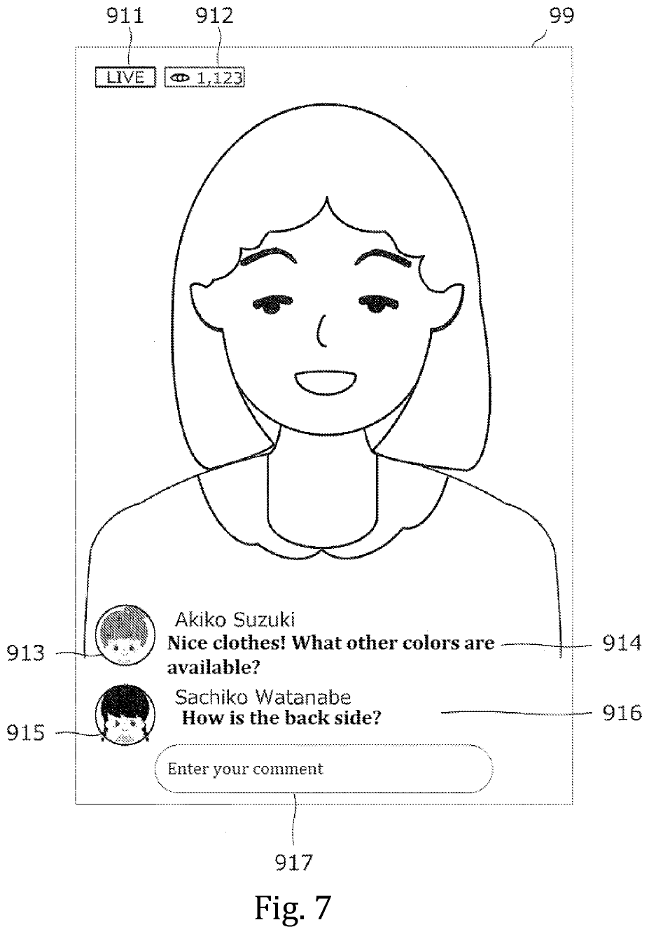

FIG. 7 illustrates a viewing screen of a live video on the viewer user terminal 40. This screen is based on the viewing application 92. The viewing screen of the live video includes a window 99. In the window 99, the video is shown on almost the entire screen. In this example, a video of a woman introducing clothes is shown on the screen. In addition to the video, various UI objects are displayed in the window 99. Here, an icon 911, an icon 912, an icon 913, a comment 914, an icon 915, a comment 916, and an input field 917 are examples of the UI objects. The icon 911 is a UI object that indicates that this video is a live video, i.e., not a recording. If the SNS 91 is a platform that allows distribution of pre-recorded videos, the icon 911 will show whether the video shown is a live video or not. The icon 912 is a UI object that indicates the number of users (i.e., viewers) watching this video.

The viewer of the live video can input his/her reactions to the live video via the UI object in the window 99. In one example, the reaction to the video is a comment. In this example, comments that meet a predetermined condition(s) are superimposed on the video. The predetermined condition is, for example, a predetermined number of comments (two in the illustrated example) in order from the one with the latest posted time. The icon 913 is a UI object representing an avatar of a user who posted the comment 914. The comment 914 is a UI object representing the posted comment (text). The same applies to the icon 915 and comment 916.

The input field 917 is a UI object for entering a new comment. A button 918 is a UI object for instructing posting of a comment. When a user clicks the button 918 after text has been entered in the input field 917, this text is posted as a comment. Any viewer of the live video or the distributor of the video can post comments at any time during the video streaming. These comments can also be viewed by the distributor at the distributor user terminal 30.

Although the screen of the viewing application 92 is shown here as an example, the screen of the distribution application 93 also has at least some UI objects common with the viewing application 92. These features enable interactive communication between the distributor and the viewers (i.e., potential orderers) in product sales through live video. For example, a viewer may ask, “What other colors are available?” when the distributor is introducing an item of clothing in a video. The distributor who sees the comment may respond to the viewer in real time by saying, “We have navy blue and beige as color variations,” or by showing the viewers the color variations of the product. When a viewer may ask, “How is the back side?” The distributor may respond to the question by turning around in front of the camera.

Comments posted by users are entered in a database that is managed by the server 10. This database includes, for each of the videos being distributed, attribute information and comment data of the video. The attribute information is information indicating the attributes of the video, including, for example, a video ID, a distributor's user ID, and a representative value (e.g., average or maximum value) of the number of viewers. The comment data represents a comment posted to the video, and includes, for example, a comment ID, a sender's user ID, the time of posting, and the text of the comment.

In this example, the server 10 sends the video data and the comment data separately to the viewer user terminal 40. The viewer user terminal 40 uses these data to generate a screen that displays the comment superimposed on the video.

Referring again to FIG. 6, with a predetermined event as a trigger, the monitoring unit 23 of the server 20 transmits a comment viewing request to the server 10 (step S106). This viewing request includes information that specifies comments to be viewed (hereinafter referred to as “comment specifying information”). The comment specifying information includes, for example, video specifying information and information for identifying comments that have been viewed. The information identifying the viewed comment indicates, for example, the time when the viewing request was last transmitted (hereinafter referred to as “previous transmission time”). Alternatively, when identification information (hereinafter referred to as “comment ID”) is given to each comment on the server 10, the comment ID may be used as the comment specifying information. The event that triggers the comment viewing request is, for example, an event in which a predetermined time has elapsed since the previous viewing request was made.

Upon receiving the request to view comments from the server 20, the server 10 extracts comments from the database that meet the condition(s) specified by the viewing request (Step S107). For example, the server 10 extracts from the database the comment data posted to the video after the previous transmission time. The server 10 sends the extracted comment data to the server 20 (Step S108). The function of responding to the comment viewing request on the server 10 is provided, for example, as an API (Application Programming Interface).

Upon receiving the comment data from the server 10, the extraction unit 24 of the server 20 extracts a keyword(s) from the received comment data (Step S109). The keyword(s) extracted here is keyword(s) related to purchase order for a product, and includes at least a character string indicating order of a product and a character string indicating the quantity of the product to be ordered. Note that the “character string” here includes those consisting of only one character. In this example, the character string indicating that a product is ordered is “+” and the character string indicating the quantity to be ordered is a numeral. The numeric portion is limited depending on the nature of the product. For example, for items sold by the piece, such as clothing, the order quantity must be a natural number. For items sold by weight, such as liquid items, the order quantity has to be a positive real number and is not necessarily be a natural number. In this example, the character strings such as “+1” or “+15” are extracted as the keywords. The former indicates that a single unit or piece of the target product is ordered, while the latter indicates that fifteen units or pieces of the target product is ordered. The extraction unit 24 informs the processing unit 25 of the extracted keywords (step S110).

The keywords extracted from the comments by the extraction unit 24 may also include information identifying the target product, for example, a product name or a product number (these are examples of the product identifiers) (in this case, it can be said that the extraction unit 24 also functions as a means of identifying the product on sale in the live video.) The server 20 stores the database in which the keywords are recorded (hereinafter referred to as “keyword database”).

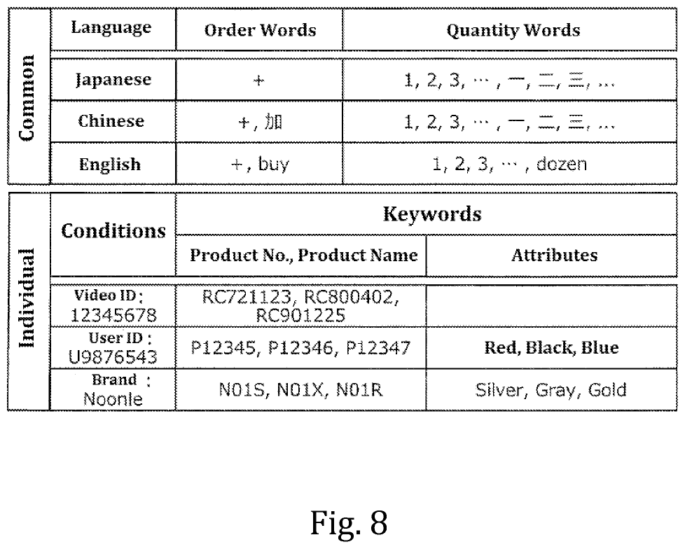

FIG. 8 illustrates the keyword database. In this example, the keyword database includes one that is commonly used for all videos (hereinafter referred to as “common database”) and one that is used only for specific videos (hereinafter referred to as “individual database”). In the common database, each record contains data for items “order words” and “quantity words”. The item “order words” is data indicating character strings (i.e., keywords) for order, and in this example, the characters (or words) “+”, “ [symbol] ” and “buy” are registered as the order words. The item “quantity words” is data indicating character strings (i.e., keywords) indicating the quantity of the product ordered, and in this example, in addition to Arabic numerals and Chinese numerals, English words such as “dozen” are registered as the quantity words. The extraction unit 24 recognizes a combination of the order word and quantity word as an order instruction from the user. The records in the common database are entered by the operator of the live commerce system 1, for example.

In the individual database, each record contains data for items “condition” and “keyword”. The item “condition” is data indicating the condition for limiting videos to which the record applies. The condition for limiting videos include, for example, (1) limiting videos by the video IDs, (2) limiting videos by the distributor using his/her user ID, and (3) limiting videos by the product handled in the video using the product field, brand name, (4) a combination of the conditions (2) and (3). The records in the individual database are entered by, for example, the operator of the live commerce system 1 or the user who is the distributor.

The item “keyword” is a string that identifies the target product, and in this example includes sub-items “product number, product name” and “attributes”. The sub-item “product number, product name” indicates the product number or product name of the product. The sub-item “attributes” indicates the attributes of the product, e.g., color variations and size.

According to the keyword database, the server 20 interprets comments submitted by viewers, for example, as follows:

“+1”, “ [symbol] 1”, or “buy 1”: Order one target product.

“RC721123 [symbol] 1”: Order one product with the product number “RC721123”.

“Buy N01X Gold 1dozen”: Order 1 dozen (12) of the product with product number “N01X” (gold in color).

The term “target product” refers to a single product that is for sale at the time the posted comment is accepted. In cases where multiple products are for sale in a single live video, the distributor provides information that at least identifies the target product to viewers, such as by posting a comment saying, “Now start to sell product X!” or other information that at least allows viewers to identify the target product.

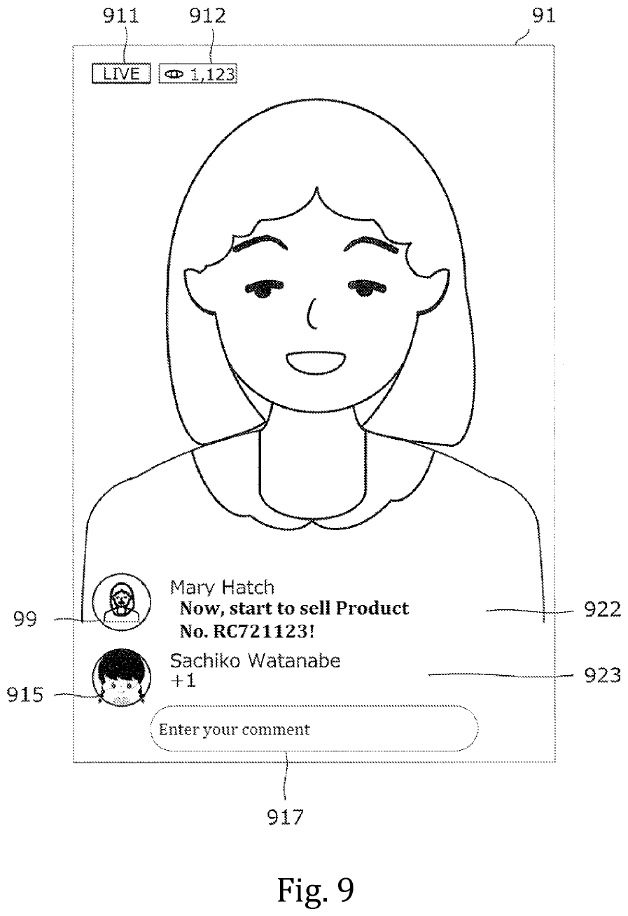

FIG. 9 illustrates a viewing screen in which comments including the keyword are posted. An icon 921 is the distributor's icon and a comment 922 is the distributor's comment. In the comment 922, the distributor says, “the product number RC721123 is now going on sale!” With the comment 922, the product with the product number RC721123 becomes the target product until the change is announced. In response to this, a viewer whose user name is “Sachiko Watanabe” posted a comment 923 stating “+1”. The extraction unit 24 of the server 20 extracts the keyword “+1” from the comment 923. The viewer who posted the comment from which the keyword was extracted is hereinafter referred to as the “orderer”.

Referring again to FIG. 6, upon receiving transmission of the keyword, the processing unit 25 performs a process related to order of a product (step S111). In this example, the process related to order of a product includes recording the order in the database and generating a reply message to the orderer.

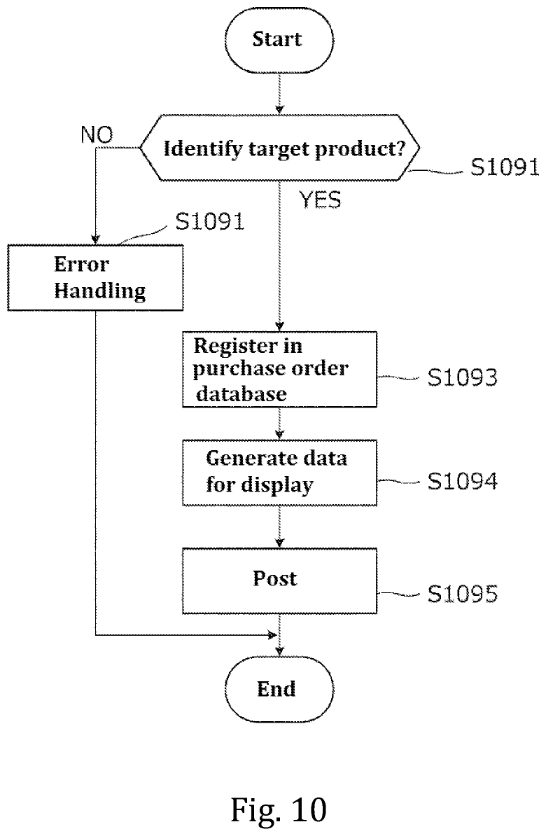

FIG. 10 is a flowchart illustrating the process related to the order of a product. In step S1091, the processing unit 25 determines whether the target product has been identified. For example, in the case where the extraction unit 24 has a function to analyze the comments posted by the distributor and automatically identify the target product, when the extraction unit 24 successfully identifies the target product from the comments, the processing unit 25 determines that the target product has been identified. Alternatively, when the extraction unit 24 extracts information that identifies the target product from the comments posted by the viewers, the processing unit 25 determines that the target product has been identified. Once it is determined that the target product has been identified (S1091: YES), the processing unit 25 proceeds to step S1093. When it is determined that the target product is not identified (S1091: NO), the processing unit 25 proceeds to step S1092.

In step S1092, the processing unit 25 performs error handling. The error handling is, for example, a process to notify the viewers that the target product cannot be identified. Specifically, the processing unit 25 notifies the viewers with a message such as “The product to be ordered cannot be identified.” Data for showing a message such as “Please enter “+1” along with the product number of the product to be ordered” on the viewing user terminal 40 is generated and outputted.

In step S1093, the processing unit 25 registers a record that the viewer has placed an order for the target product in the purchase order database. This process corresponds to adding the target product to the viewer's shopping cart in a general electronic commerce (EC) site.

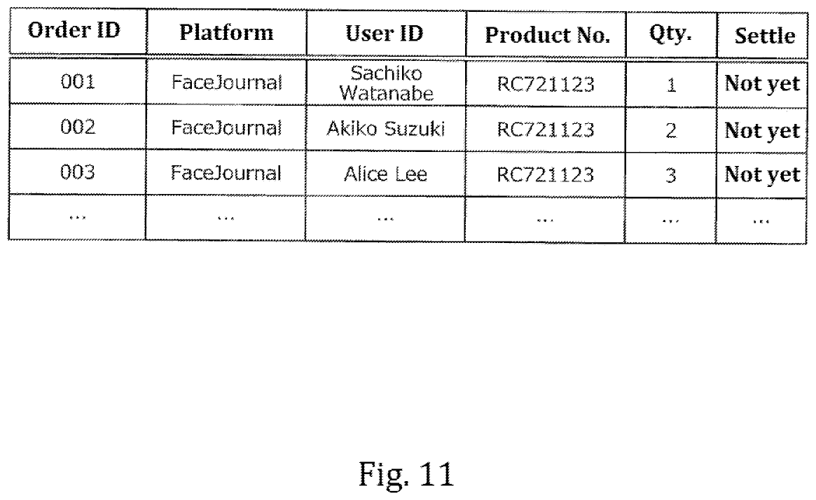

FIG. 11 illustrates the purchase order database. The purchase order database is a database for recording product orders on server 20. In this example, each record contains the following items: order ID, platform, user ID, time, item number, order quantity, and payment. The item “order ID” indicates a number that identifies each record. The item “time” indicates the time when the order was accepted (so-called time stamp). The item “platform” indicates the platform from which the order was accepted. The item “user ID” indicates the user who placed the order. The item “product number” indicates the product for which the order was placed. If the server 20 cannot automatically identify the product number, this item may be left blank. It is possible to identify the product number retroactively (manually or automatically) by matching the time stamp with the distributor's comment. The item “order quantity” indicates the quantity ordered. The item “settlement” indicates whether the payment of the product cost has been completed. The default value is “not yet”, which means that the payment has not been completed.

Referring again to FIG. 10, in step S1094, the processing unit 25 generates data for displaying, on the viewer user terminal 40, information indicating that the order for the product has been accepted. In this example, the information indicating that the order for the product has been accepted includes a comment indicating that the order for the target product has been accepted and a link to a site for payment of the purchase cost of the target product. The processing unit 25 posts the generated data to the server 10 as a reply to the comment that placed the order for the target product (i.e., the comment from which the keywords were extracted) (Step S1095). A function for accepting comment posting is provided as an API.

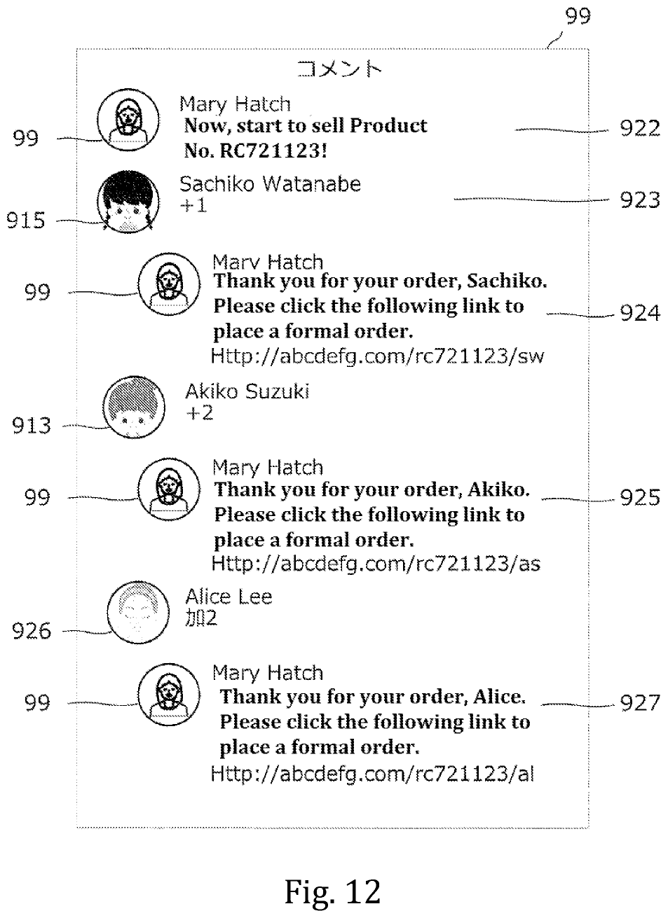

FIG. 12 illustrates a comment display screen for a video. In this embodiment, there is a limit to the number of comments that can be superimposed on a live video. When a user instructs transition to the comment display screen in the live video screen (e.g., FIG. 7), the screen transitions to the screen of FIG. 12. The transition to the comment display screen in the live video screen is instructed, for example, by clicking on the portion of the window 99 where comments are displayed.

In this example, after the comment 922 announcing the start of sales of the product with the product number “RC721123”, the user “Sachiko Watanabe” posts “+1” as a comment 923. In response to the comment 923, the comment 924 “Thank you for your order, Sachiko. Please click the following link to place a formal order within one hour. http://abcdefg.com/rc721123/sw” is posted by the server 20. The text “Thank you for your order, Sachiko” is an example of the character string indicating that the order for the target product has been accepted, and “http://abcdefg.com/rc721123/sw” is an example of a link to the site where the payment of the target product is performed. In this example, a comment that does not correspond to a specific comment (hereinafter referred to as “independent comment”) and a comment that is a reply to the specific comment (hereinafter referred to as “reply comment”) are distinguished. A set of an independent comment and reply comments to this independent comment is referred to as a “thread”. Independent comments are displayed in the order of the time when the thread was updated (e.g., the time when a new reply comment in that thread was accepted at server 10). The reply comments are shown in the thread in chronological order. The correspondence between the independent comment and the reply comments is displayed such that they are visually distinguished by line-indenting the reply comments with respect to the corresponding independent comment.

In this example, comment(s) (for example, the comment 924) posted from the server 20 to the comment (for example, the comment 923) posted by a certain user (for example, Sachiko Watanabe) can be viewed by users other than that user. However, if any users can view comments addressed to a specific user, it can be a problem. In particular, when a comment posted from the server 20 contains a link to a payment site, as in the illustrated example, another user (for example, Alice Lee) may accidentally or intentionally access the payment site and process wrongly. From the viewpoint of preventing such an accident, the server 20 may be configured to post a comment distributed to other users that only includes a character string indicating that the order for the target product has been accepted, without a link to the payment site. In this case, the server 20 may send the link to the payment site to the orderers via another method (e.g., one-to-one message exchange means (for example, Facebook® Messenger or e-mail)).

On the viewer user terminal 40 used by one user, at least one of the comment in which the user has placed an order for a product or the reply comments from the server 20 (formally from the distributor) to that user may be displayed in a manner that is visually distinct from other comments.

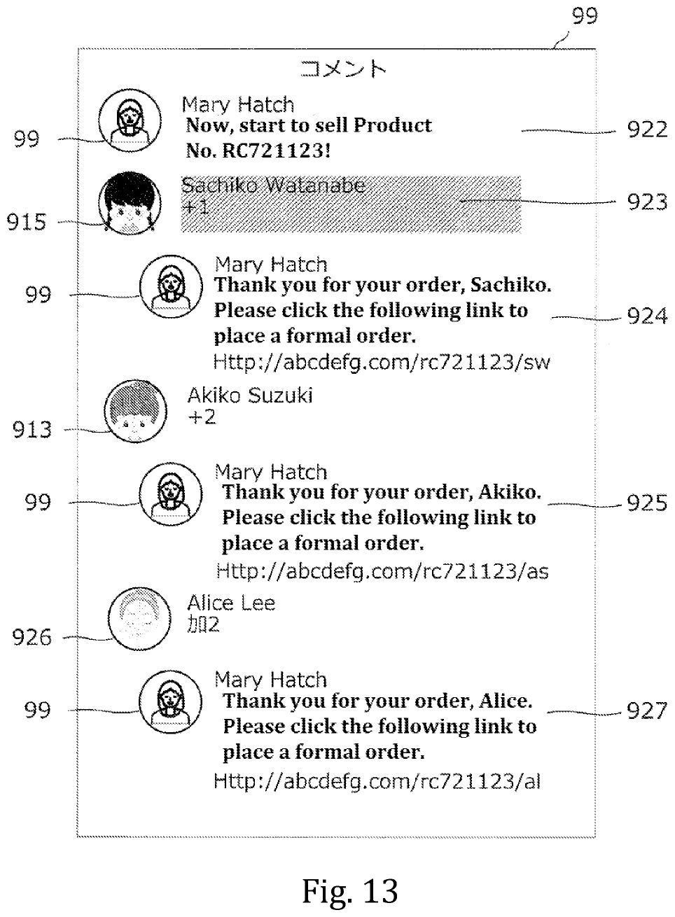

FIG. 13 illustrates another comment display screen. FIG. 13 shows a screen displayed on the viewer user terminal 40 used by the user “Sachiko Watanabe”. In this example, the background of the comment 923 is updated or changed to be different from other comments (for example, in a different color) when the order in the comment 923 posted by the user “Sachiko Watanabe” is accepted by the server 10. Comments from users other than this user (the comments from users “Akiko Suzuki” and “Alice Lee” in the example of FIG. 13) and reply comments from the distributor to other users (the comments 925 and 927 in the example of FIG. 13) are not particularly distinguished from other comments. It should be noted that the method of visually distinguishing reply comments is not limited to making the background color different. Any technique may be used, such as changing the font size, changing the font, displaying a badge on the icon, blinking the icon and/or comment, scrolling the comment on the screen, and the like. Further, the comment whose appearance is to be changed is not limited to the comment (comment 923 in the example of FIG. 13) in which the instruction to place an order for the target product is detected. The appearance of the reply comment (comment 924 in the example of FIG. 13) indicating that the order for the target product has been accepted may be also updated or changed in place of or in addition to the comment in which the instruction to place the order for the target product has been detected.

As for a specific processing for changing the appearance of the comment, for example, if the SNS 91 has a function that can specify the background color of a comment when posting the comment, the server 20 uses this function to change the background color of the comment. Alternatively, if the API of the SNS 91 provides a function of changing the background color of a comment, the server 20 may use this function to change the background color of the comment.

The process of visually distinguishing the reply comment from the distributor to himself/herself from other comments may be terminated with a predetermined event as a trigger. The event is, for example, an event that it is confirmed that the orderer has viewed this reply comment (for example, if the comment display screen has a button such as “confirmed”, the event that the distributor has viewed the replay comment can be confirmed through the clicking of the button), an event that a predetermined time has passed since the appearance was last updated, or the like.

Further, the event that triggers the process of making the appearance of the comment different from the others is not limited to the event that the server 20 accepted the order of the target product. For example, the appearance of the comment may be updated or changed when the server 20 detects the posting of a comment or detects a keyword from the comment.

In this way, the reply comments from the distributor are visually distinguished from reply comments from other users and reply comments to other users, so that the orderer can easily recognize that there is a response to his/her order from the distributor.

The reply comment from the distributor includes a link to the settlement site. The orderer accesses the link and pays the purchase cost online. The operator of the settlement system is affiliated with or the same as the operator of the live commerce system 1. When the payment is completed, the settlement system notifies the server 20 that the payment is completed. For example, the URL included in the reply comment includes information identifying the live commerce system 1 and this transaction, for example, an order ID. When the processing unit 25 of the server 20 received the notification from the settlement system, the value of the term of the corresponding record in the purchase order database is rewritten from “Settlement” to “Done”.

The acceptance of orders on the server 20 ends with a predetermined event as a trigger. The event that triggers the termination of the order acceptance is, for example, an event that the distribution of the live video has ended, or an event that a predetermined time (time specified by the live commerce system 1 or the distributor) has elapsed from the end of the live video distribution, or an event that the number of orders has reached a predetermined sales quantity.

When the server 20 terminates the acceptance of orders, it discloses at least part of the purchase order database in response to access from the orderer. The orderer uses the information recorded in the order database to place the order for the product and to perform other process.

### 3. Modification Examples

The present invention is not limited to the above-described embodiment, and various implementations are required. Hereinafter, some modification examples will be described. Two or more of the following modification examples may be used in combination.

### 3-1. Cancellation of Purchase Order

Although only the process of placing a purchase order for a product was described in the embodiment, the live commerce system 1 may cancel the order once accepted in response to an operation inputted at the viewer user terminal 40. In this case, the keyword database stores a keyword(s) indicating cancellation of an order. When the cancellation word(s) is extracted from a user's comment, the processing unit 25 performs a process of canceling the order for the target product (hereinafter referred to as “cancellation process”).

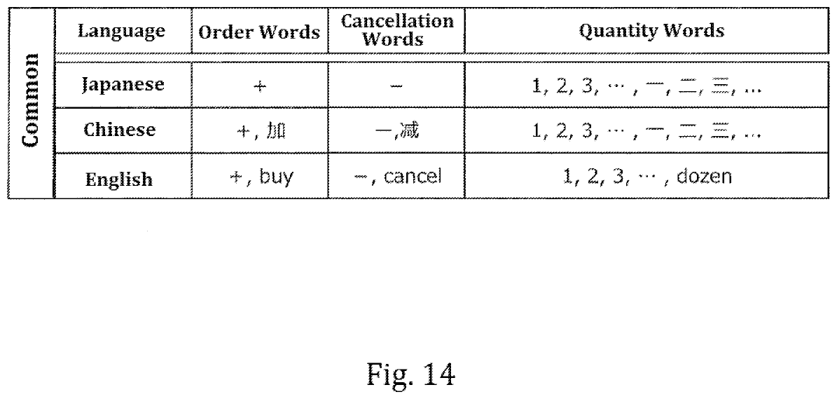

FIG. 14 illustrates a keyword database related to such a modification example. Of the keyword databases, only the common database is shown here. In this keyword database, in addition to the items “order word” and “quantity word”, the item “cancellation word” is registered. The cancellation word is data indicating the character string (that is, a keyword) for canceling the order of the target product. In this example, the character strings (words) “-”, “ [symbol] ” (in the case of simplified Chinese, it is not sanzui but nisui. In FIG. 14, expressed in simplified Chinese), and “cancel” are registered as the cancellation words. The relationship between the order words and the cancellation words may be limited by language sets. For example, when an order is accepted using Japanese order words, the server 20 may extract only Japanese cancellation words as the keywords. In this case, the server 20 may register the language used by each orderer (user) or order ID in the order database (FIG. 11) and extract cancellation words of the language used as the keywords, while cancellation words of other languages may not be extracted as the keywords.

The cancellation process is not limited to those triggered by reactions entered via UI objects on the viewer user terminal 40. The processing unit 25 may cancel an order, for example, if the payment for the order is not made within a predetermined period of time after the order is placed.

### 3-2. Input to Live Video

The inputs to be monitored by the monitoring unit 23 in the live video are not limited to those described in the above embodiment. In the embodiment, the example in which the monitoring unit 23 monitors comments posted by viewers has been described. The monitoring unit 23 may monitor other inputs (or reactions) in addition to or instead of the comments. For example, the window 99 (See FIG. 7, 12 or 13) may have one or more UI objects for accepting reaction from other users to each comment, and the monitoring unit 23 may monitor inputs made via the one or more UI objects. More specifically, the monitoring unit 23 monitors inputs via a specific first UI object among the plurality of UI objects included in the display screen of the live video. The first UI object is a UI object for updating a user's reaction to the live video, and the reaction state is updated each time the user operates the first UI object. In one example, when the SNS 91 is Facebook (registered trademark), the UI object to be monitored is the “like button” (an example of the first UI object). For example, when a user A presses the like button and the monitoring unit 23 detects that the reaction state is now “Like!” (an example of a first state of the reaction), the processing unit 25 performs the process of accepting an order for the target product. After this, the user A presses the like button again and the monitoring unit 23 detects that the “Like!” state has been released (an example of a second state of the reaction), the processing unit 25 cancels the order for the target product.

In another example, when the screen of the live distributed video has the first UI object and the second UI object, the monitoring unit 23 may monitor the input via these UI objects. For example, when the monitoring unit 23 detects an input via the first UI object, the processing unit 25 performs the process related to the purchase order for the target product. When the monitoring unit 23 detects an input via the second UI object, the processing unit 25 performs the cancellation process (provided that the order for the target product has been placed). In one example, when the SNS 91 is twitter (registered trademark), the “like icon” is an example of the first UI object, and the “retweet button” is an example of the second UI object.

### 3-3. Reaction from System

In response to the viewer's input to the live video, the reaction transmitted from the live commerce system 1 (specifically, the server 20) to the viewer is not limited to that exemplified in the above embodiment. When the reaction is a reply comment, the reply comment may include only one of the information indicating that the order for the product has been accepted or the link to the site for settling the purchase cost of the product. Instead of or in addition to this, the reply comment may include information indicating the inventory of the product. In this case, the server 20 has information about the inventories of products. For example, the server 20 has a database showing the inventories of products, and each time an order is received, the server 20 performs a process of allocating the inventory to the orderer.

Further, the server 20 may post information regarding the attributes of the product (particularly, information that changes over time such as the inventory of the target product) as a comment. This information may be posted in response to an event that is not related to viewer input. The event that triggers this comment posting is, for example, an event that a predetermined time has elapsed since the previous information provision.

### 3-4. Display Reply Comments

The method of displaying the reply comments is not limited to that described in the above embodiment. The reply comment is not displayed only on the comment display screen, but may also be displayed superimposed on the video. In this case, the independent comment and the reply comment may be visually distinguished by displaying the reply comment at a position different from the independent comment or moving the replay comment differently from the independent comment on the video screen. Further, when a reply comment from the distributor to the orderer is displayed on the viewer user terminal 40 of the orderer, it may be displayed in an appearance distinctive from reply comments from the distributor to other viewers or reply comments from other users to the orderer.

When displaying the reply comments, the viewer user terminal 40 may display the appearance of all the reply comments from the distributor visually different from the independent comment regardless of the destination, that is, the corresponding independent comment. In this example, it is possible to easily recognize that there is a reply comment from the distributor to any of the viewers, although it is not necessarily addressed to oneself.

### 3-5. Identify Target Product

The method of identifying the target product during distribution of the live video is not limited to those described in the above embodiment. For example, the server 20 may provide a UI screen for selecting one target product from a list of pre-registered target product candidates to the distributor user terminal 30. When the distributor finishes introducing one product in the video and starts introducing another product, he/she operates this UI screen to select the next target product. In this case, the server 20 (specifically, the processing unit 25) identifies the target product in response to the distributor's operation on this UI screen. Alternatively, the server 20 may analyze the text of the comments posted by the distributor and use the results of this analysis to identify the target product. Alternatively, the server 20 may analyze the distributor's voice in the live video and use the results of this analysis to identify the target product. Machine learning techniques, such as AI (Artificial Intelligence) technology, may be used to identify the target product from these analysis results.

When the cancellation process is performed, the processing unit 25 specifies, for example, the product most recently ordered by the user as the target product. Alternatively, when the user inputs the product number together with the cancellation word in the comment inputted, the processing unit 25 may specify the product indicated by the product number as the target product.

### 3-6. Method of Monitoring Inputs

The method by which the live stream system 1 monitors the reactions of the viewers is not limited to that described in the above embodiment. In the embodiment, the server 20 monitors the reaction of the viewer by making an inquiry to the server 10 via the API. The live commerce system 1 may use other method in place of or in addition to this method. As another method, for example, an agent is activated in the viewer user terminal 40 and this agent monitors the reaction input by a user. The agent in this case is another example of the monitoring unit. The agent is an application program that runs in the background of the viewing application 92. When the agent detects that the user has made a specific input, the agent transmits the requested information to the server 20. The requested information includes, for example, a user identifier, the information inputted, and the identification information of the UI object through which the input was made.

### 3-7. UI Screen

The configuration of the live video distribution screen and related screens (the comment screen, and the like) is not limited to that described in the above embodiment. For example, in the viewer user terminal 40, a comment from a user may not be superimposed on the live video and may be displayed in an area different from the live video. That is, the area for displaying the live video and the area for displaying comments from a user may be separated.

### 3-8. Scope of Processing

The process performed by the processing unit 25 when the monitoring unit 23 extracts a specific input from the user's input is not limited to that described in the above embodiment. In the embodiment, in response to the extraction of a specific input from the user inputs by the monitoring unit 23, the processing unit 25 performs the process equivalent to placing the product in a shopping cart in the context of a normal e-commerce site. Alternatively, the processing unit 25 may perform a process of payment of the cost of the product in the shopping cart in response to the extraction of the specific input from the user inputs by the monitoring unit 23. In this example, for example, the user simply inputs “+1” in the comment field of the live video to complete the purchase order and payment for the target product.

### 3-9. Network Configuration

In the above embodiment, the network configuration of FIG. 5A has been mainly described, but the live commerce system 1 may have the network configuration of FIG. 5B. In this case, the server 20 may perform a process of superimposing the reply comment generated on the server 20 on the video shot by the distributor user terminal 30 and generating a video data containing comments. This is especially useful when live video is distributed to multiple different platforms at the same time. For example, when a viewer to which the live video is distributed on a platform A makes the comment, “How is the back side?”, this comment “How is the back side?” is conventionally displayed on user terminals on the platform A. Thus, even if the distributor turns his/her back, the viewers can see that he/she does this to respond to the comment. However, the comment “How is the back side?” is not displayed on user terminals on a platform B, so when the distributor turns around, the viewers on the platform B do not understand why the distributor suddenly turned around. To address this, the distributor may post comment “I received a question about the back side, so I'm turning around” and the server 20 composites this comment into the video itself, then the comment “I received a question about the back side, so I'm turning around” will be superimposed on the video regardless of the platform. This method is useful, for example, for displaying information that changes in real time, such as ▪ quantity of inventory.

### 3-10. Other Modification Examples

The hardware configuration of each device and the correspondence between the functional configuration and the hardware configuration are not limited to those described in the embodiment. A device having any hardware configuration may be used as long as it can realize the required function(s). For example, the server or user terminal may have no storage and may have storage in a (other) server (so-called cloud). Further, the division of functions among hardware devices constituting the live commerce system 1 is not limited to those described in the embodiment. For example, another hardware device may have some of the functions that are described as the server 20 has in the embodiment.

A program to be executed by the processor 201 or the like may be downloaded from another server via a communication network such as the Internet, or may be provided as stored in a non-transitory recording medium such as a CD-ROM.

1. A server device comprising:
a monitoring unit monitoring inputs performed by a plurality of users through one or more UI objects displayed together with a live video on a terminal of each of the plurality of users, the live video being about a product and distributed to the plurality of users from a first user;
an extraction unit extracting, from the inputs, a specific input related to a purchase order for the product;
a processing unit performing a process of accepting the purchase order for the product upon extraction of the specific input; and
an output unit, upon extraction of the specific input, outputting data for displaying information regarding the purchase order for the product on a terminal used by a second user who made the specific input among the plurality of users.

2. The server device of claim 1, wherein the one or more UI objects include a first object for accepting input of comments about the live video,
wherein the monitoring unit monitors the comments,
wherein the extraction unit extracts, from the comments, a first key word that indicates the purchase order of the product, and
wherein the output unit outputs the data in response to extraction of the first key word.

3. The server device of claim 2, wherein the extraction unit extracts a second key word from comments inputted by the second user, the second key word corresponding to the first key word and indicating cancellation of the purchase order for the product, and
wherein the server device further includes a cancellation unit canceling the purchase order for the product upon extraction of the second key word from the comments inputted by the second user.

4. The server device of claim 2, wherein the extraction unit extracts a character string that indicates a combination of an identifier and order quantity of the product.

5. The server device of claim 1, wherein the extraction unit extracts, as the specific input, an input for specifying at least one selecting from the group consisting of an identifier, an attribute, and an order quantity of the product.

6. The server device of claim 1, wherein the output unit outputs, as the data, data for displaying a comment on the terminal, the comment indicating the purchase order for the product has been accepted.

7. The server device of claim 1, wherein the output unit outputs, as the data, data for displaying a link on the terminal, the link linking to a site for settling a purchase cost of the product.

8. The server device of claim 1, wherein the output unit outputs, as the data, data for displaying a comment corresponding to the specific input, the comment being superimposed on the live video.

9. The server device of claim 1, wherein the output unit outputs data for displaying, on the terminal, a first UI object among the one or more UI objects corresponding to the live video on the terminal, the first UI object showing the input of the second user with a different appearance from a second UI object that shows an input of a third user different from the second user.

10. The server device of claim 1, wherein the output unit outputs data for displaying, on the terminal, a third UI object among the one or more UI objects corresponding to the live video on the terminal, the specific input by the second user being extracted from the third UI object with a different appearance from a fourth UI object from which no specific input is extracted.

11. The server device of claim 9, wherein the output unit outputs the data in response to acceptance of the purchase order for the product by the processing unit.

12. The server device of claim 1, further comprising:
an identifying unit identifying a product on sale in the live video,
wherein, upon identification of the product on sale in the live video by the identifying unit, the extraction unit extracts an input that indicates an order quantity as the specific input.

13. The server device of claim 1, wherein upon extraction of the specific input, the processing unit perform a process of settling a purchase cost of the product.

14. An electronic commerce transaction method, comprising:
monitoring inputs performed by a plurality of users through one or more UI objects displayed together with a live video on a terminal of each of the plurality of users, the live video being about a product and distributed to the plurality of users from a first user;
extracting, from the inputs, a specific input related to a purchase order for the product;
performing a process of accepting the purchase order for the product upon extraction of the specific input; and
upon extraction of the specific input, outputting data for displaying information regarding the purchase order for the product on a terminal used by a second user who made the specific input among the plurality of users.
